(19) United States
(12) Patent Application Publication
(10) Pub. No.: US 2009/0267830 A1
(43) Pub. Date: Oct. 29, 2009

(54) METHOD FOR DETERMINING THE DISTANCE BETWEEN POSITIONING DEVICES AND GROUND MONITORING SYSTEM USING THE METHOD

(75) Inventors: SHU-JEN TSAI, Tu-Cheng (TW); WEN-HAW TSENG, Tu-Cheng (TW); SHIH-FANG WONG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/351,855

(22) Filed: Jan. 12, 2009

(30) Foreign Application Priority Data
Apr. 24, 2008 (CN) 200810301285.7

(51) Int. Cl. G01S 5/14

(52) U.S. Cl. 342/357.08

(57) ABSTRACT

A method for determining a distance between positioning devices includes following steps. A ground monitoring system receiving positions of a first positioning device and a second positioning device. The ground monitoring system determining a distance between the first positioning device and the second positioning device according to the positions of the first positioning device and the second positioning device. The ground monitoring system transmitting said distance to at least one of the first positioning device and the second positioning device.

### CROSS-REFERENCE TO RELATED APPLICATIONS

This application is related to the following commonly-assigned co-pending application Ser. No. 12/189,119, entitled “POSITIONING DEVICE AND METHOD FOR MEASURING THE DISTANCE BETWEEN MULTIPLE POSITIONING DEVICES”, filed on Aug. 8, 2008; and Ser. No. 12/261,038, entitled “POSITIONING DEVICE AND METHOD FOR MEASURING THE DISTANCE BETWEEN MULTIPLE POSITIONING DEVICES”, filed on Oct. 30, 2008. The Disclosures of the above-identified applications are incorporated herein by reference.

### BACKGROUND

1. Technical Field

Embodiments of the present disclosure generally relate to a method for determining the distance between positioning devices and a ground monitoring system using the method.

2. Description of Related Art

Positioning devices are widely used in electronic products such as mobile phones and personal digital assistants (PDAs).

Commonly, a positioning device includes a receiving module, a processing module, and a display module. The receiving module receives positioning signals transmitted from satellites. The processing module determines a position of the positioning device using the positioning signals. The display module displays the position of the positioning device on an electronic map. Thus, the position of the positioning device can be known by a user of the positioning device.

However, a distance between two positioning devices is generally not known.

Therefore, a method for determining the distance between positioning devices and a system capable of implementing such method are needed to address the aforementioned deficiencies and inadequacies.

### BRIEF DESCRIPTION OF THE DRAWINGS

FIG. 1 is a flow chart of a method for determining the distance between positioning devices in accordance with an exemplary embodiment.

FIG. 2 is a block diagram of a communication system including two positioning devices and a ground monitoring system, in accordance with an exemplary embodiment.

FIG. 3 is a block diagram of either one of the positioning devices of FIG. 2.

FIG. 4 is a block diagram of the ground monitoring system of FIG. 2.

### DETAILED DESCRIPTION OF EXEMPLARY EMBODIMENTS

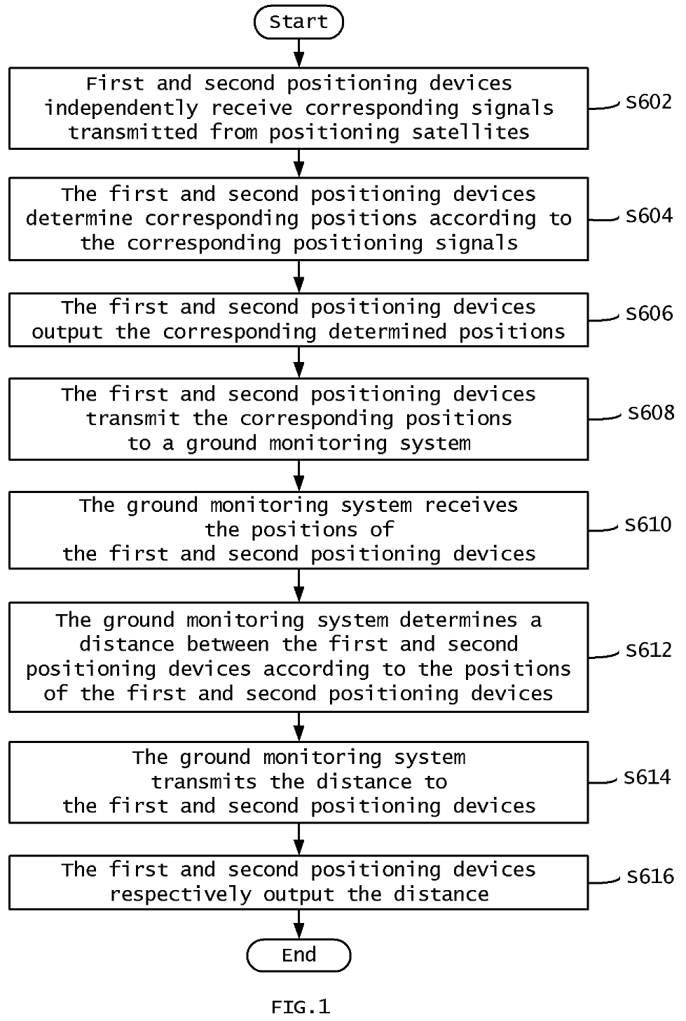

Referring to FIG. 1, a flow chart of a method for determining the distance between positioning devices in accordance with an exemplary embodiment is shown. The various actions in the method may be performed in the order presented, or may be performed in a different order. Furthermore, in some embodiments, some actions shown in FIG. 1 may be omitted from the method. The method shown includes the following blocks.

Beginning in block S602, a first positioning device and a second positioning device independently receive corresponding positioning signals wirelessly transmitted from positioning satellites.

In block S604, corresponding positions of the first positioning device and the second positioning device are determined according to the corresponding positioning signals, independently.

In block S606, the first positioning device and the second positioning device output the corresponding positions via at least one medium of data images and audible sounds. Thereby, the positions of the first and second positioning devices can be known by users of the first and second positioning devices, respectively. The first and second positioning devices may include display screens for displaying the corresponding positions on electronic maps. The first and second positioning devices may also include speakers for outputting audible sounds describing the corresponding positions. Typically, the audible sounds are in the form of human speech.

In block S608, the first positioning device and the second positioning device wirelessly transmit the corresponding positions to a ground monitoring system.

In block S610, the ground monitoring system receives the positions of the first positioning device and the second positioning device.

In block S612, the ground monitoring system computes a distance between the first positioning device and the second positioning device according to the positions of the first positioning device and the second positioning device. In the following description, such distance is referred to as “separation distance.”

In block S614, the ground monitoring system wirelessly transmits the separation distance to the first positioning device and the second positioning device.

In block S616, the first positioning device and the second positioning device output the separation distance. Thereby, the separation distance can also be known by the users of the first and second positioning devices.

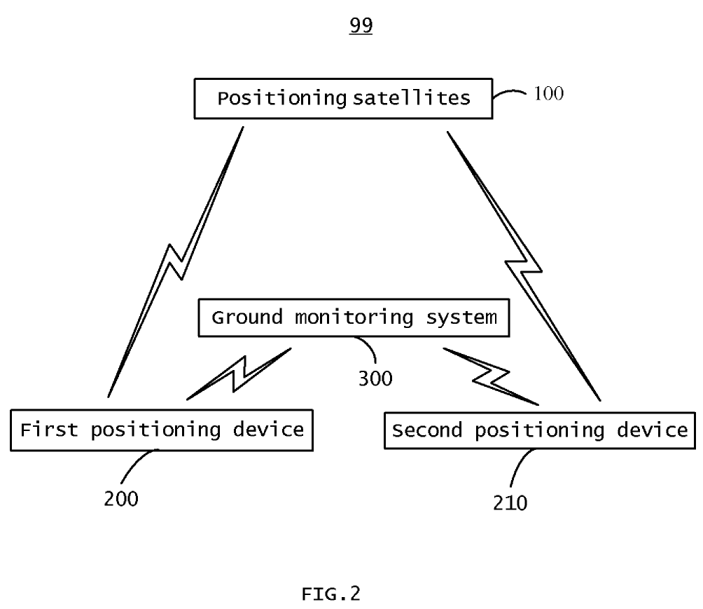

Referring to FIG. 2, a communication system 99 includes a first positioning device 200, a second positioning device 210, positioning satellites 100 for transmitting positioning signals to the first positioning device 200 and the second positioning device 210, and a ground monitoring system 300. Each of the first positioning device 200 and the second positioning device 210 may for example be a mobile phone or a personal digital assistant (PDA), which has a global positioning system (GPS) module.

The first and second positioning devices 200, 210 are used for independently receiving the corresponding positioning signals wirelessly transmitted from the positioning satellites 100, determining corresponding positions according to the corresponding positioning signals, and then wirelessly transmitting the corresponding positions to the ground monitoring system 300.

The ground monitoring system 300 is capable of communicating with the first and second positioning devices 200, 210. The ground monitoring system 300 is used for receiving the positions of the first positioning device 200 and the second positioning device 210, determining a distance between the first positioning device 200 and the second positioning device 210 (hereinafter, “separation distance”) according to the positions of the first positioning device 200 and the second positioning device 210, and then wirelessly transmitting the separation distance to the first positioning device 200 and the second positioning device 210.

The first positioning device 200 and the second positioning device 210 respectively output the separation distance. Therefore not only can the positions of the first positioning device 200 and the second positioning device 210 be known by users thereof, respectively, but also the separation distance can be known.

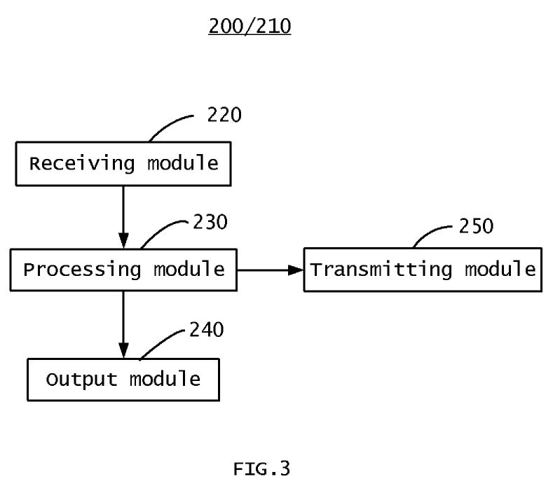

Referring also to FIG. 3, the first positioning device 200 includes a receiving module 220, a processing module 230, an output module 240, and a transmitting module 250.

The receiving module 220 receives the positioning signals transmitted from the positioning satellites 100.

The processing module 230 is electrically connected with the receiving module 220, and is for determining the position of the first positioning device 200 according to the positioning signals received by the receiving module 220.

The output module 240 outputs the position of the first positioning device 200 via at least one medium of data images and audible sounds. Therefore, the position of the first positioning device 200 can be known by the user thereof. The output module 240 may be a display screen displaying the position of the first positioning device 200 on an electronic map. The first output module 240 may also include a speaker for outputting audible sounds describing the position of the first positioning device 200.

The transmitting module 250 connected with the processing module 230 wirelessly transmits the position of the first positioning device 200 to the ground monitoring system 300.

The second positioning device 210 may for example be identical with the first positioning device 200.

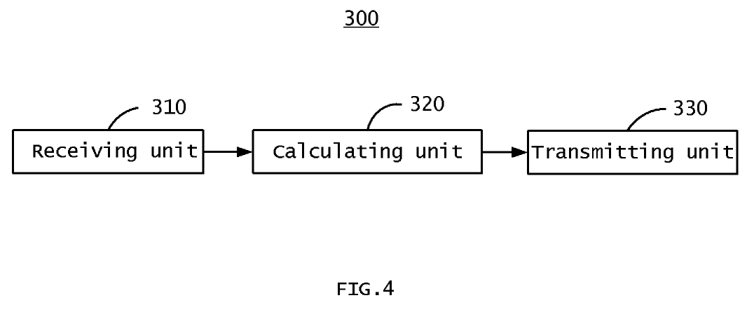

Referring also to FIG. 4, the ground monitoring system 300 includes a receiving unit 310, a calculating unit 320, and a transmitting unit 330. The receiving unit 310 receives the positions of the first positioning device 200 and the second positioning device 210.

The calculating unit 320 determines the separation distance according to the positions of the first positioning device 200 and the second positioning device 210.

The transmitting unit 330 wirelessly transmits the separation distance to the first positioning device 210 and the second positioning device 220.

The receiving module 220 of the first positioning device 210 is used for receiving the separation distance transmitted from the ground monitoring system 300.

The output module 240 of the first positioning device 210 is used for outputting the separation distance. Therefore, the separation distance can be known by the user of the first positioning device 210.

It is to be understood, however, that even though numerous information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A method for determining a distance between positioning devices, the method comprising:
a ground monitoring system receiving positions of a first positioning device and a second positioning device;
the ground monitoring system determining a distance between the first positioning device and the second positioning device according to the positions of the first positioning device and the second positioning device; and
the ground monitoring system transmitting said distance to at least one of the first positioning device and the second positioning device.

2. The method according to claim 1, wherein the ground monitoring system wirelessly transmits said distance to said at least one of the first positioning device and the second positioning device.

3. A ground monitoring system comprising:
a receiving unit for receiving positions of two positioning devices;
a calculating unit for determining a distance between the two positioning devices according to the positions of the two positioning devices; and
a transmitting unit for transmitting said distance to at least one of the two positioning devices.

4. The ground monitoring system according to claim 3, wherein the ground monitoring system is capable of wirelessly transmitting said distance to said at least one of the two positioning devices.

5. A method for determining a distance between positioning devices, the method comprising:
a first positioning device and a second positioning device independently receiving positioning signals transmitted from positioning satellites;
the first positioning device and the second positioning device determining their respective positions according to the positioning signals;
the first positioning device and the second positioning device transmitting their positions to a ground monitoring system;
the ground monitoring system determining a distance between the first positioning device and the second positioning device according to the positions of the first positioning device and the second positioning device;
the ground monitoring system transmitting said distance to at least one of the first positioning device and the second positioning device; and
said at least one of the first positioning device and the second positioning device respectively outputting said distance to a user.

6. The method according to claim 5, wherein the first positioning device and the second positioning device wirelessly transmit their positions to the ground monitoring system.

7. The method according to claim 5, wherein the ground monitoring system wirelessly transmits said distance to said at least one of the first positioning device and the second positioning device.

8. The method according to claim 5, further comprising:
the first positioning device outputting the position thereof to a user.

9. The method according to claim 5, further comprising:
the second positioning device outputting the position thereof to a user.
